(19) United States
(12) Patent Application Publication
(10) Pub. No.: US 2019/0198204 A1
(43) Pub. Date: Jun. 27, 2019

(54) METHOD FOR MAKING RESISTORS

(71) Applicant: Ralec Electronic Corporation, Kaohsiung (TW)

(72) Inventors: Wan-Ping WANG, Kaohsiung (TW); Chen-Ling TSAI, Kaohsiung (TW)

(21) Appl. No.: 16/223,681

(22) Filed: Dec. 18, 2018

(30) Foreign Application Priority Data
Dec. 26, 2017 (TW) 106145678

(51) Int. Cl. H01C 17/22; H01C 17/28

(52) U.S. Cl. CPC H01C 17/22; H01C 17/28

(57) ABSTRACT

A method for making resistors includes: forming a protective layer on a metal plate; patterning the metal plate to form a plurality of spaced-apart resistor wires; forming a plurality of bottom parts on the metal plate, each of the bottom parts covering a portion of a respective one of the resistor wires such that the respective resistor wire defines two opposite electrode forming regions; laser-marking the protective layer to form a plurality of identification codes; laser-cutting the protective layer and the metal plate to form a plurality of spaced-apart pre-formed resistors; and forming two terminal electrodes respectively on the two opposite electrode forming regions of each of the resistor wires.

### CROSS-REFERENCE TO RELATED APPLICATION

This application claims priority of Taiwanese Invention Patent Application No. 106145678, filed on Dec. 26, 2017.

### FIELD

The disclosure relates to a method for making resistors, more particularly to a method for making resistors involving the use of laser.

### BACKGROUND

Referring to FIG. 1, a resistor 1 includes a resistor wire 11, an upper part 12 connected to an upper surface of the resistor wire 11, an identification code 13 formed on the upper part 12, a bottom part 14 connected to a bottom surface of the resistor wire 11, and two terminal electrodes 15 formed on two opposite sides of the resistor wire 11. The resistor wire 11 is formed by cutting a metal plate, and provides a predetermined resistance value. The upper and bottom parts 12, 14 are made of electrically insulating materials and protectively cover the resistor wire 11, such that the resistor wire 11 is electrically insulated from its surroundings. The identification code 13 is formed by printing, and provides information about the resistor such as resistance value thereof, model number thereof, etc. After the resistor 1 is soldered to a circuit board (not shown in figures) via the terminal electrodes 15 and forms a part of an electrical circuit of the circuit board, the resistor wire 11 provides the predetermined resistance value to the electrical circuit. The resistance value may depend on the shape of the resistance wire 11 and the resistance coefficient of the material of the resistance wire 11. Because the resistor 1 has a simple structure and is easy to produce, and has characteristics such as small size, high precision and reliability, and being non-inductive in practical circuitry applications, it has been widely used as a passive component in electrical machines and devices.

Referring to FIG. 2, a conventional method of making resistors includes steps 21 to 26.

In step 21, a protective layer is formed on a front surface of the metal plate. In step 22, a rear surface of the metal plate opposite to the front surface is cut to form a plurality of the resistor wires 11 spaced apart from each other. In step 23, an electrical insulating material is printed on the rear surface of the metal plate to form a plurality of spaced-apart bottom row parts. Each of the bottom row parts covers a portion of a respective row of the resistor wires 11, such that each of the resistor wires 11 defines two opposite electrode forming regions exposed from the bottom row part. In step 24, identification code 13 is printed onto each of the resistor wires 11 by screen-printing. In step 25, the protective layer, the bottom row parts, and the metal plate are punched with respect to each of the resistor wires 11 to obtain a plurality of pre-formed resistors, the protective layer and the bottom row parts respectively forming a plurality of the upper parts 12 and a plurality of the bottom parts 14. In step 26, each of the pre-formed resistors is electroplated to form the two terminal electrodes 15 on the electrode forming regions to complete the making of the resistor 1.

The conventional method of making the resistor 1 may be applied for mass production of the resistor 1. However, with increasing demands in miniaturization of passive components with a high dimensional precision, the conventional method for making the resistor 1 needs to be improved for the following reasons: screen-printing the identification code 13 on the upper part 12 of the small-sized resistor 1 using oil-based ink is difficult to perform, and punching the protective layer and the bottom row parts does not achieve a sufficient level of precision.

### SUMMARY

Therefore, the object of the disclosure is to provide a method for making resistors that can alleviate at least one of the drawbacks of the prior art.

According to the disclosure, the method for making resistors includes:
forming a protective layer on a front surface of a metal plate, the protective layer being made of a first electrically insulating material;
patterning a rear surface of the metal plate to form a plurality of spaced-apart resistor wires;
forming a plurality of bottom parts on the rear surface of the metal plate, each of the bottom parts covering a portion of a respective one of the resistor wires such that the respective resistor wire defines two opposite electrode forming regions that are exposed from the bottom part, the bottom parts being made of a second electrically insulating material;
laser-marking the protective layer to form a plurality of identification codes, each of which corresponds in position to a respective one of the resistor wires;
laser-cutting the protective layer and the metal plate to form a plurality of spaced-apart pre-formed resistors, each of which includes an upper part defined by the protective layer, a respective one of the identification codes marked on the protective layer, a respective one of the resistor wires, and the respective bottom part covering the resistor wire; and
forming two terminal electrodes respectively on the two opposite electrode forming regions of each of the resistor wires.

### BRIEF DESCRIPTION OF THE DRAWINGS

Other features and advantages of the disclosure will become apparent in the following detailed description of the embodiment with reference to the accompanying drawings, of which:

FIG. 1 is a schematic view of a conventional resistor;

FIG. 2 is a flow chart showing a conventional method of making the conventional resistors;

FIG. 3 is a flow chart showing an embodiment of a method of making resistors according to this disclosure;

FIG. 4 is a schematic view of the resistor made by the embodiment;

FIG. 5 is a fragmentary schematic view illustrating formation of a protective layer on a metal plate;

FIG. 6 is a fragmentary schematic view illustrating patterning of a rear surface of the metal plate;

FIG. 7 is a fragmentary schematic view illustrating formation of a plurality of bottom parts on the rear surface of the metal plate;

FIG. 8 is a fragmentary schematic view illustrating laser-marking of the protective layer to form a plurality of identification codes; and

FIG. 9 is a close-up view of FIG. 8, illustrating removal of a portion of the protective layer.

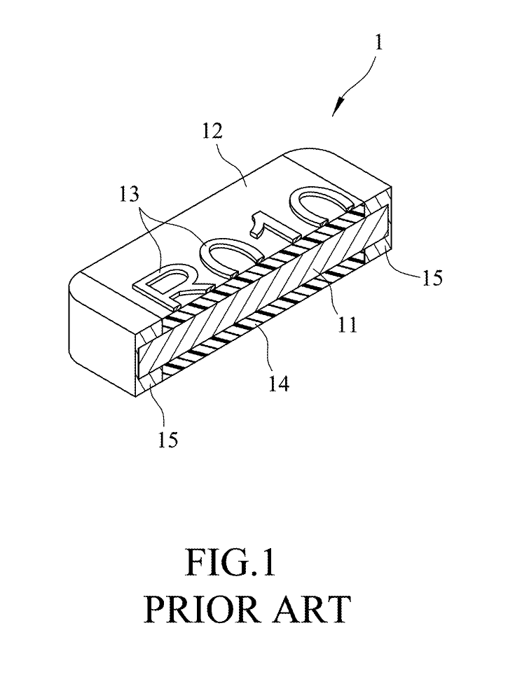

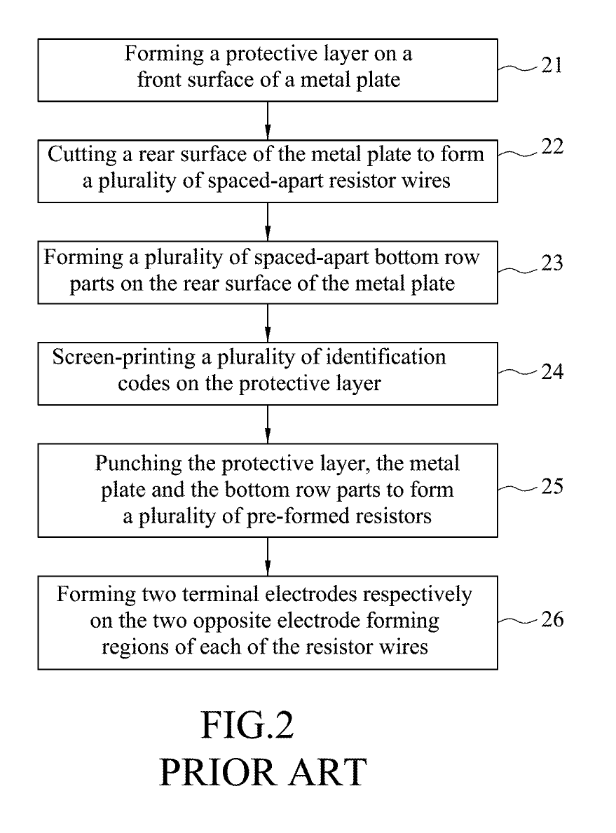

### DETAILED DESCRIPTION

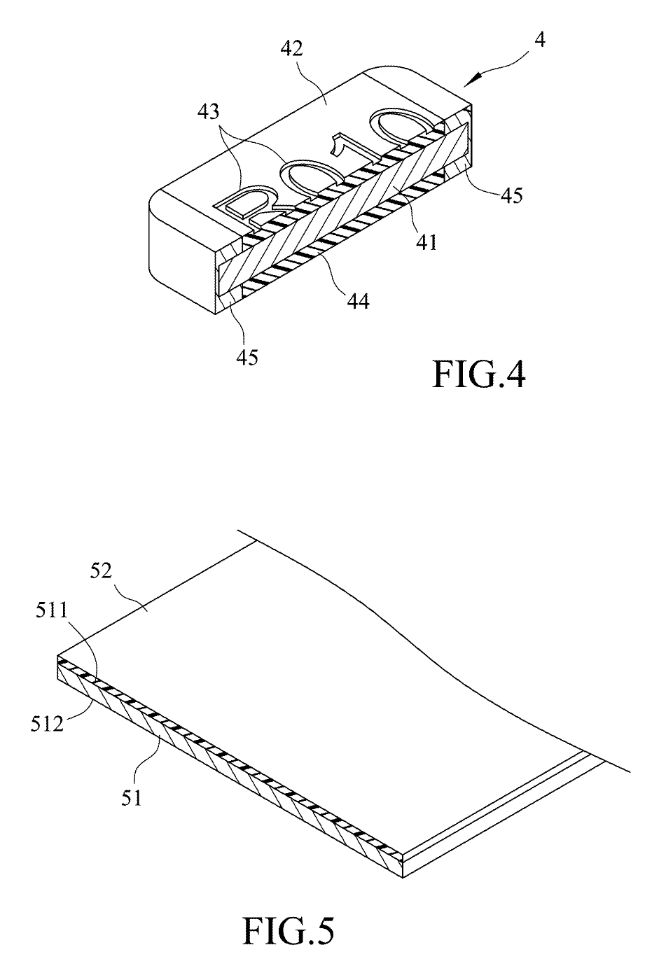

Referring to FIG. 4, a resistor 4 made by a method according to this disclosure is shown to be structurally similar to a resistor produced by a conventional method, and includes a resistor wire 41, an upper part 42 connected to an upper surface of the resistor wire 41, an identification code 43 formed on the upper part 42, a lower part 44 connected to a lower surface of the resistor wire 41, and two terminal electrodes 45 formed on two opposite sides of the resistor wire 41. The difference between the resistor produced by the conventional method and the resistor 4 of the present disclosure is that, the identification code 43, and the upper and bottom parts 42, 44 are formed using lasers, allowing the resistor 4 to have smaller size and higher precision.

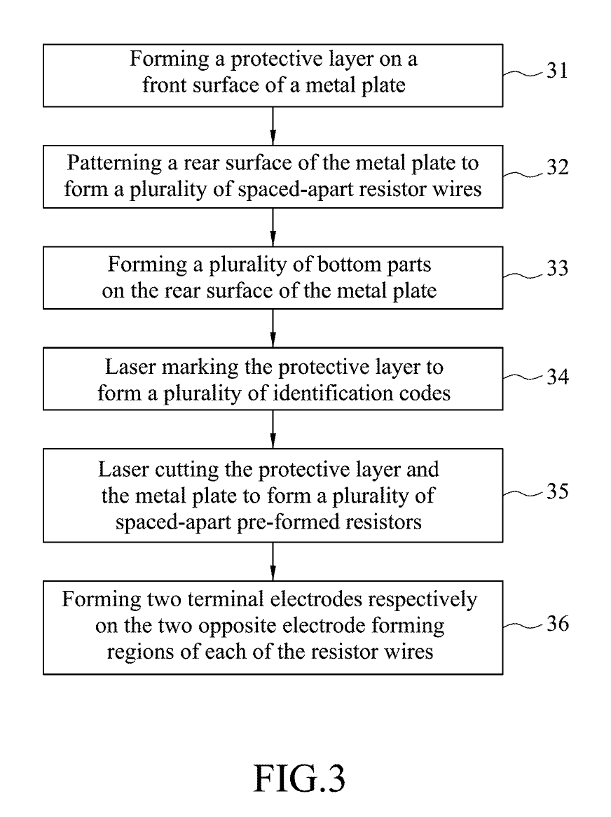

Referring to FIG. 3, an embodiment of the method for making a plurality of the resistors 4 according to this disclosure includes steps 31 to 36.

Referring to FIGS. 3 and 5, in step 31, a protective layer 52 is formed on a front surface 511 of a metal plate 51. The protective layer 52 is made of a first electrically insulating material. In this embodiment, the first electrically insulating material is selected from polyimide and photosensitive insulating ink, and is formed on the front surface 511 by hot-pressing (in the case of polyimide) or printing (in the case of photosensitive insulating ink). The metal plate 51 may be made of a manganese copper nickel alloy, a manganese copper tin alloy, an iron chromium aluminum alloy, a nickel chromium copper aluminum alloy, or combinations thereof.

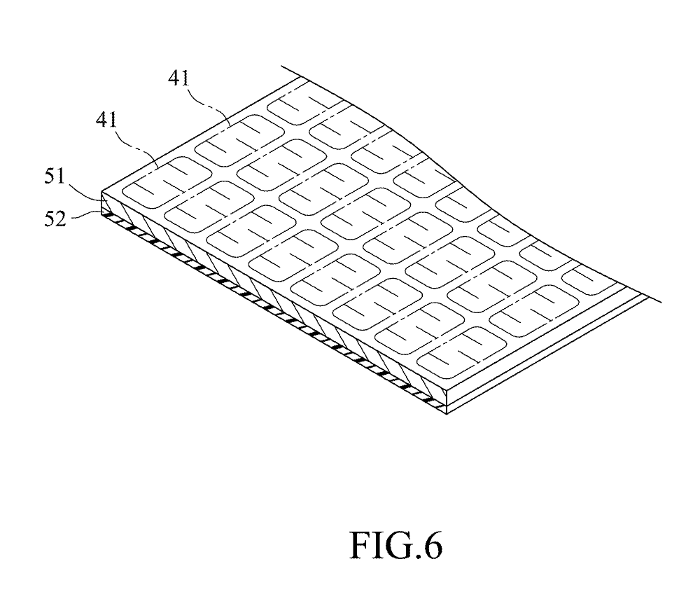

Referring to FIGS. 3 and 6, in step 32, a rear surface 512 of the metal plate 51 is patterned to form a plurality of the resistor wires 41, which are spaced apart from each other. In this embodiment, photolithography and etching techniques are used for patterning the rear surface 512 of the metal plate 51.

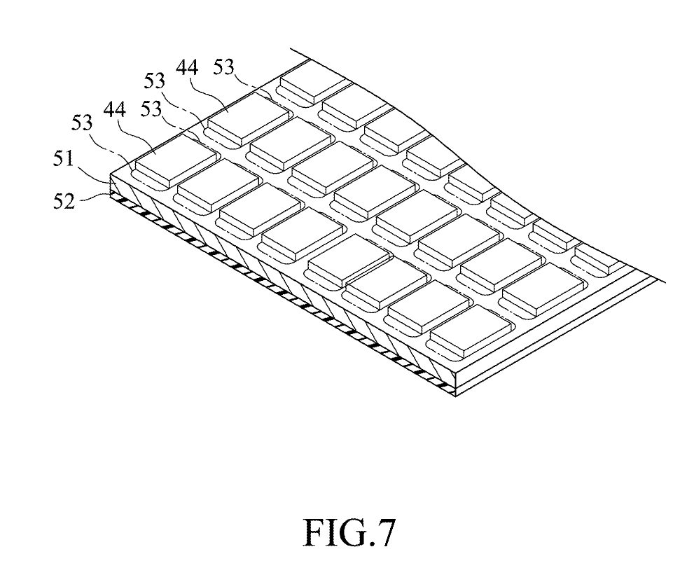

Referring to FIGS. 3 and 7, in step 33, a plurality of the bottom parts 44 are formed on the rear surface 512 of the metal plate 51. Each of the bottom parts 44 covers a portion of a respective one of the resistor wires 41 such that the respective resistor wire 41 defines two opposite electrode forming regions 53 that are exposed from the bottom part 44. The bottom parts are made of a second electrically insulating material. In this embodiment, the second electrically insulating material is selected from photosensitive insulating ink and printing insulating ink, and the bottom parts 44 are formed by printing on the rear surface 512. Further processing may be conducted on the resistor wires 41 based on practical requirements. For example, a test (e.g., resistance value test) may be conducted on the resistor wires 41. For the resistor wire 41 that fails the test, the respective one of the bottom parts 44 is removed to expose the resistor wire 41, and then the respective resistor wire 41 is reformed, followed by reconstructing the respective one of the bottom parts 44. Such a test may improve a yield of the resistor 4.

Referring to FIGS. 3, 4, and 8, in step 34, the protective layer 52 is laser-marked to forma plurality of the identification codes 43. Each of the identification codes 43 corresponds in position to a respective one of the resistor wires 41.

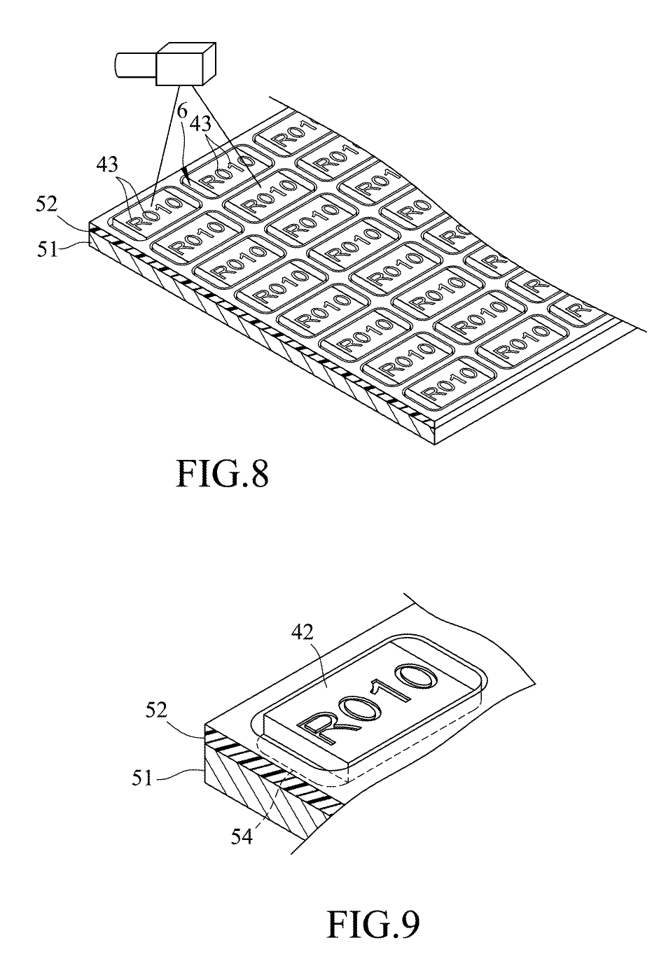

In step 35, the protective layer 52 and the metal plate 51 are laser cut to form a plurality of spaced-apart pre-formed resistors 6 (see FIG. 8). Each of the pre-formed resistors 6 includes the upper part 42 defined by the protective layer 52, a respective one of the identification codes 43 marked on the protective layer 52, a respective one of the resistor wires 41, and the respective bottom part 44 covering the resistor wire 41. In certain embodiments, as further shown in FIG. 9, a portion of the upper part 42 of one of the pre-formed resistors 6 is removed such that the resistor wire 41 of the one of the pre-formed resistor 6 defines an electrode forming upper region 54 that is exposed from the upper part 42. In certain embodiments, after formation of the identification codes 43, removal of the portion of the upper part 42 of the pre-formed resistor 6 is performed, followed by laser-cutting of the protective layer 52 and the metal plate 51.

In this embodiment, laser with 3%-10% of maximum power and a speed of 300-500 mm/second is used to form the identification codes 43, laser with 60%-90% of maximum power and a speed of 50 to 100 mm/second is used to remove the portion of the upper part 42, and laser with 40%-60% of maximum power and a speed of 40 to 60 mm/second is used to cut the protective layer 52 and the metal plate 51. It should be noted that the laser power may be adjusted based on practical requirements. In certain embodiments, the bottom parts 44 may be laser cut to change the dimensions of the electrode forming regions 53 of each of the resistor wires 41.

In step 36, the terminal electrodes 45 are respectively formed on the two opposite electrode forming regions 53 of each of the resistor wires 41. In certain embodiments, one of the terminal electrodes 45 is then connected to the electrode forming upper region 54.

In sum, by virtue of the method for making resistors of this disclosure, the laser is used not only to form the identification codes 43, but also to remove a portion of the upper part 42 and to cut the metal plate 51 and the protective layer 52 so as to obtain the plurality of the pre-formed resistors 6. Therefore, in view of miniaturization trends of electrical passive components with high dimensional precision, mass production of the resistors 4 having miniaturized size with the identification codes 43 precisely marked can be accomplished.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for making resistors, comprising:
forming a protective layer on a front surface of a metal plate, the protective layer being made of a first electrically insulating material;
patterning a rear surface of the metal plate to form a plurality of spaced-apart resistor wires;
forming a plurality of bottom parts on the rear surface of the metal plate, each of the bottom parts covering a portion of a respective one of the resistor wires such that the respective resistor wire defines two opposite electrode forming regions that are exposed from the bottom part, the bottom parts being made of a second electrically insulating material;
laser-marking the protective layer to form a plurality of identification codes, each of which corresponds in position to a respective one of the resistor wires;
laser-cutting the protective layer and the metal plate to form a plurality of spaced-apart pre-formed resistors, each of which includes an upper part defined by the protective layer, a respective one of the identification codes marked on the protective layer, a respective one of the resistor wires, and the respective bottom part covering the resistor wire; and
forming two terminal electrodes respectively on the two opposite electrode forming regions of each of the resistor wires.

2. The method of claim 1, further comprising laser-cutting the bottom parts to change dimensions of the electrode forming regions of each of the resistor wires.

3. The method of claim 1, further comprising removing one of the bottom parts to expose the respective resistor wire, reforming the respective resistor wire, and reconstructing the one of the bottom parts.

4. The method of claim 1, further comprising removing a portion of the upper part of one of the pre-formed resistors such that the resistor wire of the one of the pre-formed resistor defines an electrode forming upper region exposed from the upper part, and connecting one of the terminal electrodes to the electrode forming upper region.

5. The method of claim 4, wherein, after the formation of the identification codes, the removal of the portion of the upper part of the pre-formed resistor is performed, followed by the laser-cutting of the protective layer and the metal plate.

6. The method of claim 1, wherein the first electrically insulating material is selected from polyimide and photosensitive insulating ink.

7. The method of claim 1, wherein the second electrically insulating material is selected from photosensitive insulating ink and printing insulating ink.
